(19) United States
(12) Patent Application Publication
(10) Pub. No.: US 2026/0188033 A1
(43) Pub. Date: Jul. 2, 2026

(54) GENERATIVE AI-BASED FRAMEWORK FOR DETECTING AND ANALYZING ARTIFICIALLY-MANIPULATED IMAGES

(71) Applicant: SocialTrendly, Inc. d/b/a/ Blackbird.AI, Rochester, NY (US)

(72) Inventors: Abul Hasnat, Noisy le Grand (FR); Yazid Lachachi, Rochester, NY (US); Naushad UzZaman, Bellmore, NY (US)

(73) Assignee: SocialTrendly, Inc. d/b/a Blackbird.AI, Rochester, NY (US)

(21) Appl. No.: 19/431,820

(22) Filed: Dec. 23, 2025

Related U.S. Application Data
(60) Provisional application No. 63/738,991, filed on Dec. 26, 2024.

(51) Int. Cl. G06V 20/00; G06F 21/64; G06V 10/764; G06V 10/77; G06V 10/82

(52) U.S. Cl. CPC G06V 20/95; G06F 21/64; G06V 10/764; G06V 10/7715; G06V 10/82

(57) ABSTRACT

Disclosed embodiments may provide systems and methods for detecting and analyzing artificially-manipulated images. A computer-implemented method can include processing an image using an ensemble of machine-learning models to generate a set of initial outputs. In some instances, each machine-learning model of the ensemble was trained to generate an initial output predictive of whether a portion of the image corresponds to a particular type of artificially-manipulated visual content. The computer-implemented method can also include processing the set of initial outputs using an ensemble-aggregator model to generate a target output. In some instances, the target output includes a classification of whether the image corresponds to an artificially-manipulated image. The computer-implemented method can also include processing the set of initial outputs and the target output using a multimodal machine-learning model to generate a narrative content that describes one or more types of artificially-manipulated visual content predicted to be present on the image.

### CROSS-REFERENCES TO RELATED APPLICATIONS

The present application claims priority from and is a non-provisional of U.S. Provisional Application No. 63/738,991, entitled “GENERATIVE AI-BASED FRAMEWORK FOR DETECTION AND ANALYZING ARTIFICIALLY-MANIPULATED IMAGES” filed Dec. 26, 2024, the contents of which are herein incorporated by reference in its entirety for all purposes.

### FIELD

The present disclosure relates generally to detecting artificially-manipulated images. In one example, the systems and methods described herein may be used to implement an ensemble of machine-learning models to identify various types of artificially-manipulated images.

### SUMMARY

Disclosed embodiments may provide a generative AI-based framework for detecting and analyzing artificially-manipulated images. A computer-implemented method can include accessing an image. In some instances, the image corresponds to a video frame of a plurality of video frames. The computer-implemented method can also include processing the image using an ensemble of machine-learning models to generate a set of initial outputs. In some instances, the ensemble-aggregator model is trained using gradient boosting ensemble learning techniques.

In some instances, each machine-learning model of the ensemble was trained to generate an initial output predictive of whether a portion of the image corresponds to a particular type of artificially-manipulated visual content. In some instances, the initial output includes a visual heatmap, in which the visual heatmap identifies one or more pixels of the image processed by a corresponding machine-learning model to generate the initial output.

The computer-implemented method can also include processing the set of initial outputs using an ensemble-aggregator model to generate a target output. In some instances, the target output includes a classification of whether the image corresponds to an artificially-manipulated image.

The computer-implemented method can also include processing the set of initial outputs and the target output using a multimodal machine-learning model to generate a narrative content that describes one or more types of artificially-manipulated visual content predicted to be present on the image. For example, the narrative content may describe that: (i) the portion is an artificial-intelligence (AI) generated image; (ii) the portion is an output generated by a face-manipulation algorithm; (iii) the portion was modified from an original version of the image; and/or (iv) the portion includes contextually inconsistent visual content.

The computer-implemented method can also include outputting the target output and the narrative content.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Features, embodiments, and advantages of the present disclosure are better understood when the following Detailed Description is read with reference to the accompanying drawings.

FIG. 1 illustrates different types of artificially-manipulated images, according to some embodiments.

FIG. 2 illustrates an example schematic diagram for detecting and analyzing artificially-manipulated images, according to some embodiments.

FIG. 3 illustrates an example computing environment for detecting and analyzing artificially-manipulated images, according to some embodiments.

FIG. 4 shows an illustrative example of a process for detecting and analyzing artificially-manipulated images, in accordance with some embodiments.

FIG. 5 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Artificially-manipulated images are generated using advanced artificial intelligence (AI) techniques to manipulate or generate realistic but fake visuals. These artificially-manipulated images can pose significant societal challenges. At times, they can be weaponized to spread misinformation, damage reputations, or influence public opinion. These deceptive visuals undermine trust in digital media, making it increasingly difficult to distinguish between authentic and manipulated visual content. Artificially-manipulated images also raise ethical and legal concerns, especially when used for malicious purposes, such as non-consensual or fraudulent visual content. As the technology becomes more accessible, the potential for harm grows, highlighting the urgent need for robust detection tools, public awareness, and regulatory frameworks to mitigate their impact.

With the rapid advancement of AI-generated content (e.g., deepfakes), and the increasing ease with which images can be altered or manipulated, there is a clear and urgent need for a system capable of detecting these manipulations at scale. As image manipulation technologies evolve, it is inevitable that detection systems must also evolve to meet these challenges. Accordingly, there is a growing need for a comprehensive solution that could address the wide variety of manipulations applied to digital images. However, existing techniques do not fully cover the detection of diverse manipulation types, such as AI-generated content, face manipulation, pixel-level forgery, and contextual anomalies. Such gap in existing techniques highlights the necessity of developing a system capable of detecting a broad spectrum of manipulations within a unified framework.

Additionally, existing techniques fall short in terms of providing detailed explanations for their classification decisions. For example, existing techniques that generate image-analysis heatmaps lack the depth needed to fully explain how decisions are made. Such lack of transparency can limit user trust and understanding of the results. The need for transparency in AI decision-making is apparent in various fields, as machine learning systems are increasingly used for critical tasks. It is no longer sufficient for systems to simply make predictions; they must also explain their decisions in a way that is understandable to users. Accordingly, existing techniques often lack the scope to address various manipulation techniques and provide only limited transparency, offering simple visual outputs without clear reasoning behind the decisions.

To address the aforementioned deficiencies, the present techniques provide an Multi-Manipulated Image Detection System which addresses the growing issue of detecting and analyzing a wide range of manipulated images, including AI-generated content, face alterations, and pixel-level tampering. In effect, the Multi-Manipulated Image Detection System can protect users who are exposed to artificially-manipulated images that are increasingly used to spread misinformation and disinformation across social media and other platforms.

In some implementations, the present techniques integrate computer vision and generative AI technologies to deliver highly accurate detection results. For example, the present techniques utilize Multimodal Large Language Models (MLLM), which not only identify visual inconsistencies but also provide detailed, human-readable explanations of the decisions. The use of MLLM facilitates more transparent and interpretable content than existing techniques, allowing the users to fully understand why an image was classified as manipulated or authentic. The combination of detection accuracy and explainability ensures that users can trust the system's decisions, making it a useful tool for industries combating manipulated content and striving to maintain information integrity in a rapidly changing digital landscape.

The present techniques can be advantageous because they address the need for accurately detecting artificially-manipulated images. As manipulation techniques become more sophisticated, the ability to distinguish between authentic and manipulated content is necessary for maintaining trust in digital media. The present techniques are configured to: (i) identify a wide range of manipulations, including AI-generated content, face alterations, and pixel-level tampering; and (ii) provide human-readable explanations for the decisions. By offering detailed justifications for its classifications, the present techniques enhance user confidence in their generated results, and can be readily used in sectors like media, law enforcement, and content moderation where image integrity is paramount. The combination of accuracy, explainability, and real-time processing makes the present techniques an improved solution for combating the spread of manipulated content.

Beyond social media, the present techniques can be used in newsrooms, media organizations, and fact-checking agencies, in which verifying the authenticity of visual content is crucial to maintaining public trust. In law enforcement and forensic investigations, the present techniques can aid in detecting doctored images used in criminal activities, fraud, or evidence tampering. The present techniques can also be leveraged to monitor and mitigate the spread of disinformation that can have severe social and political impacts.

Accordingly, the present techniques can be an improvement over existing artificially-manipulated detection systems for several reasons. First, the present techniques are directed to a holistic detection system capable of detecting a wide range of manipulations, including AI-generated content, face manipulations, image forgeries, and local in-painting. Unlike existing techniques that narrowly focus on specific manipulation types or specialize in a single task, the present techniques address the full spectrum of manipulation challenges within a unified architecture.

Second, the present techniques are directed to an integrated multi-classifier framework that combines independent classifiers optimized for distinct manipulation types (e.g., AI-generated image detection, face manipulation detection, image forgery detection, and visual-contextual anomaly detection). Existing techniques rely on single-purpose classifiers or address single problems without considering the entirety of visual manipulations in a unified solution. By contrast, the present techniques integrate outputs from multiple classifiers into a hybrid model, ensuring robustness and adaptability to complex manipulation scenarios.

Third, the present techniques provide advanced explainability through contextual analysis that incorporates Multimodal Large Language Models (MLLMs) to provide both visual heatmaps and context-aware textual reasoning. Unlike existing techniques that offer only limited visual indicators or focus solely on detection, the present techniques provide comprehensive, human-readable explanations. The explanation feature addresses the growing demand for user trust and accountability in high-stakes environments. The integration of multimodal explainability ensures users can understand and justify the system's decisions.

Fourth, the present techniques provide broader and more accurate manipulation coverage. In particular, the present techniques detect advanced manipulation techniques such as pixel-level forgery and local in-painting, which are largely overlooked by existing techniques. This broader coverage ensures a comprehensive defense against visual manipulations within a unified solution.

Fifth, the present techniques implement a hybrid classifier for final decision-making, which aggregates outputs from multiple classifiers and combines them with additional feature embeddings to make a final decision. This approach captures complex relationships across manipulation types, delivering a cohesive and accurate classification result. Existing techniques currently lack hybrid classifiers that combine decisions from multi-manipulated image classifier outputs.

Finally, the present techniques implement a visual-contextual anomaly classifier that combines visual semantic analysis and real-world contextual reasoning in natural scenes to detect anomalies, such as inconsistencies in object behavior or scene elements. Existing techniques relying on pixel-level inconsistencies or semantic detection lack this advanced multimodal reasoning.

### I. Overview

In an era where visual content is proliferating at an unprecedented rate across social media platforms, the threat posed by artificially-manipulated or machine-generated images has intensified, amplifying the spread of misinformation and disinformation. To confront this growing challenge, present techniques are provided for detecting and analyzing artificially-manipulated images, utilizing the latest advancements in Computer Vision and Generative AI. A defining aspect of our system is its integration of MLLM, which not only detect contextual visual inconsistencies but also deliver transparent, human-readable explanations for its findings. By combining state-of-the-art machine learning algorithms with cutting-edge generative AI techniques, the present techniques reshape the landscape of manipulated image detection. Accordingly, the present techniques set a new benchmark for both detection accuracy and interpretability, equipping users with the tools to understand and trust the system's decisions.

### A. Artificially-Manipulated Images

As used herein, artificially-manipulated images refer to images having fully or partially altered visual content. In some instances, the visual content of the artificially-manipulated images can be entirely generated using computer vision and machine-learning techniques. These manipulations are typically implemented by deep-learning models such as Generative Adversarial Networks (GANs) and Diffusion Models, but can also include earlier, known methods such as image splicing, in-painting, or forgery.

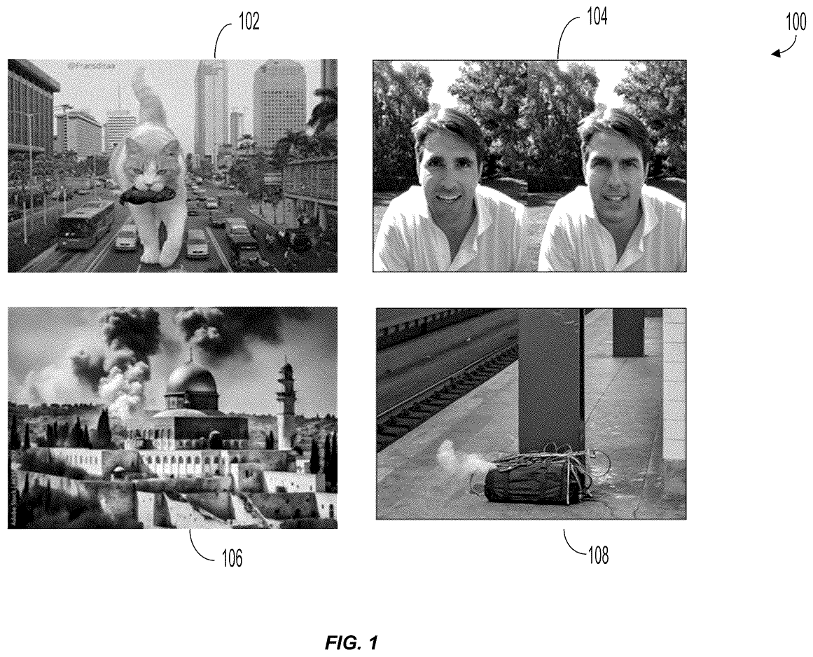

The artificially-manipulated images can vary in complexity, ranging from complete generation to partial alteration of specific portions of the images. For instance, deepfake technologies often focus on face-swapping, with prominent examples including FaceSwap, Face2Face, and NeuralTextures. These existing techniques rely heavily on GAN-based architectures to synthesize realistic human faces. In addition to deepfakes, other existing techniques utilize diffusion machine-learning models to perform highly targeted manipulations, such as generating or altering specific portions of an image (e.g., local image in-painting). As an illustrative example, FIG. 1 illustrates different types of artificially-manipulated images 100, according to some embodiments.

An image 102 corresponds to an artificially-manipulated image with splicing and forgery. The artificially-manipulated image with splicing and forgery involves altering the visual content of the image 102 by combining visual elements from multiple sources (splicing) or modifying specific parts to create false or misleading visual content (forgery). Splicing can include cutting and merging sections of different images to produce a composite that appears seamless and authentic. Forgery, on the other hand, may include digitally editing details such as faces, objects, or backgrounds to deceive viewers or misrepresent reality. These editing techniques often leverage advanced image-editing tools and algorithms to enhance believability, making detection challenging without specialized analysis.

An image 104 corresponds to an artificially-manipulated image with face manipulation (e.g., Deepfake). The artificially-manipulated image with face manipulation can involve altering or replacing a subject's face depicted in the image 104 to create a highly realistic but false representation. The face manipulation is typically achieved using advanced machine learning techniques, such as deep neural networks, which analyze and replicate facial features, expressions, and movements. The manipulated face can be seamlessly blended onto another body or context, often making it indistinguishable from the original without detailed forensic analysis. These technologies are frequently used for entertainment or satire but can also be exploited for misinformation or identity deception.

An image 106 corresponds to a fully AI-generated image. The fully AI-generated image can a synthetic visual content generated entirely by artificial intelligence, often to deceive or harm to the public. These synthetic images, often generated using techniques like Generative Adversarial Networks (GANs), can fabricate highly realistic scenes, faces, or objects that do not exist in reality. When used maliciously, such images may support scams, propagate misinformation, impersonate individuals, or manipulate public opinion. Their realism and ability to mimic authentic visuals make them a powerful tool for deception, especially when combined with disinformation campaigns or identity theft schemes.

An image 108 corresponds to a locally generated AI Inpaint image. The locally generated AI inpaint image can include modified visual content using inpainting techniques, which can be processed directly on a user's device. Inpainting typically involves filling in missing, damaged, or intentionally removed parts of the image 108 by synthesizing plausible content that matches the surrounding area. For example, inpainting can include modifying portions of the image 108, such as removing incriminating details, fabricating evidence, or creating misleading visuals, while ensuring the changes blend seamlessly with the original visual content. By generating these manipulations locally, malignant users can bypass cloud-based oversight or forensic monitoring, enabling covert actions that exploit the realism of AI-generated edits for scams, defamation, or other malicious intents.

Given the rapid evolution of AI-driven manipulation techniques, the scope of this problem extends beyond traditional deepfake detection and encompasses a wider array of synthetic content creation and modification techniques. Therefore, we define this expanded problem space as artificially-manipulated image detection, to ensure integrity of visual content across various domains.

### B. Example Implementation

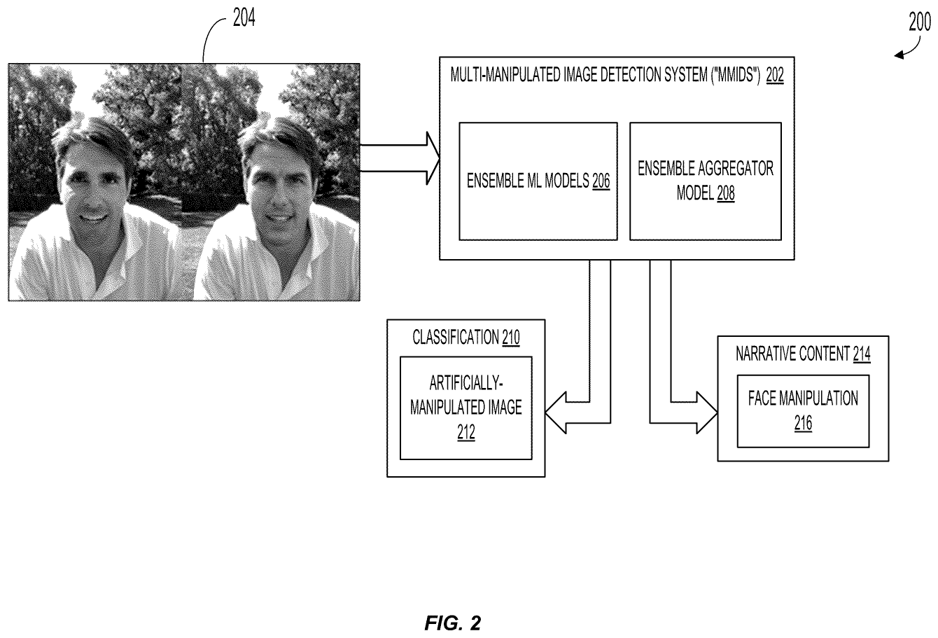

FIG. 2 illustrates an example schematic diagram 200 for detecting and analyzing artificially-manipulated images, according to some embodiments. In FIG. 2, the Multi-Manipulated Image Detection System (hereinafter referred to as “MMIDS”) can address the escalating threat of misinformation and disinformation in today's digital landscape. As visual content proliferates across social media platforms, manipulated images are increasingly used to mislead the public and spread false narratives. MMIDS is configured to identify and analyze AI-generated and manipulated such images. By detecting a broad range of manipulations, MMIDS is advantageous for content moderation on social media platforms, helping to prevent the viral spread of misleading or harmful information.

Continuing with the examples in FIG. 2, an multi-manipulated image detection system 202 accesses an image 204. The image 204 shows an artificially-manipulated image with face manipulation (e.g., Deepfake). The image 204 includes a visual representation of the subject's face captured by a camera device (e.g., a smartphone camera, video recorder). The image 204 includes a matrix of pixels, in which each pixel identifies color (e.g., RGB values) and intensity information. In some instances, the image 204 can be encoded in file formats such as JPEG, PNG, or TIFF. The image 204 can also be associated with metadata that identifies additional information about how or when the subject's face was captured.

The multi-manipulated image detection system 202 processes the image 204 using an ensemble of machine-learning models 206 to generate a set of initial outputs. In some instances, each machine-learning model of the ensemble 206 was trained to generate an initial output predictive of whether a portion of the image corresponds to a particular type of artificially-manipulated visual content. As previously explained in FIG. 1, the particular type of artificially-manipulated visual content can include: (i) an artificially-manipulated image with splicing and forgery; (ii) an artificially-manipulated image with face manipulation; (iii) a fully AI-generated image; (iv) a locally generated AI Inpaint image; and (v) an image with contextual anomalies.

The multi-manipulated image detection system 202 then processes the set of initial outputs using an ensemble-aggregator model 208 to generate a target output. In some instances, the target output includes a classification 210 of whether the image corresponds to an artificially-manipulated image. Continuing with the example, the classification 210 can indicates that the image 204 corresponds to an artificially-manipulated image 212.

In addition to generating the classification 210, the multi-manipulated image detection system 202 processes the set of initial outputs and the target output using a multimodal machine-learning model to generate a narrative content 214 that describes one or more types of artificially-manipulated visual content predicted to be present on the image 204. Continuing with the example, the narrative content 214 can indicate that the image 204 includes portions that were generated or modified using face manipulation 216. The classification 210 and the narrative content 214 can then be presented on a user interface of a client device or transmitted to another device for further analysis.

As a result, MMIDS can accurately detect a wide range of manipulations—including AI-generated content, deepfakes, and pixel-level tampering—while offering transparent, human-readable explanations through Multimodal Large Language Models (MLLM). Such narrative content can foster user trust in high-stakes environments such as media, law enforcement, and content moderation, in which clear reasoning behind detection decisions should be used. Accordingly, MMIDS offers a transparent and interpretable solution to combat the growing threat of misinformation through manipulated visual content.

MMIDS is also highly scalable and configured for near-real-time processing, making it effective in high-traffic environments like social media platforms. As described herein, it modular architecture allows seamless integration with existing content management systems through API integration, making it adaptable for various industries, including media, forensics, brand protection, and government use. By enabling fast, accurate detection and explanation of manipulated images, MMIDS offers a robust tool for organizations to maintain content integrity and combat the spread of disinformation.

### II. Techniques for Detecting and Analyzing Artificially-Manipulated Images

The present techniques mark a significant breakthrough in the field of image authenticity verification, offering a comprehensive solution to the escalating challenge of identifying artificially-manipulated images. As described herein, the present techniques leverage cutting-edge Generative AI in conjunction with advanced Computer Vision techniques to automatically detect and analyze manipulated visual content.

MMIDS not only identifies manipulations—whether they involve fully AI-generated images, partial alterations, or classical methods like splicing—but also provides human-readable explanations for each detection. By incorporating advanced models such as Vision Language Models (VLMs), MMIDS offers unparalleled transparency, detailing the reasoning behind each decision and enabling users to better understand the manipulations within the image.

The ability to detect a wide range of manipulations, from subtle in-painting to sophisticated deepfake generation, sets MMIDS apart from existing approaches. Moreover, the explainability feature ensures that users are not left with opaque, binary results but are instead equipped with a detailed breakdown of the manipulations detected and the contextual factors involved.

### A. Computing Environment

MMIDS integrates a range of advanced machine learning and computer vision techniques to detect image manipulations, spanning conventional forms of forgery to state-of-the-art AI-generated content. By leveraging specialized visual classifiers, cutting-edge machine learning models, and pixel-level image forgery analysis tools, MMIDS provides a comprehensive and highly accurate solution for detecting various types of image manipulation. Additionally, MMIDS enhances interpretability by offering explainable insights that support the final classification decision through a multimodal Vision Language Model (VLM).

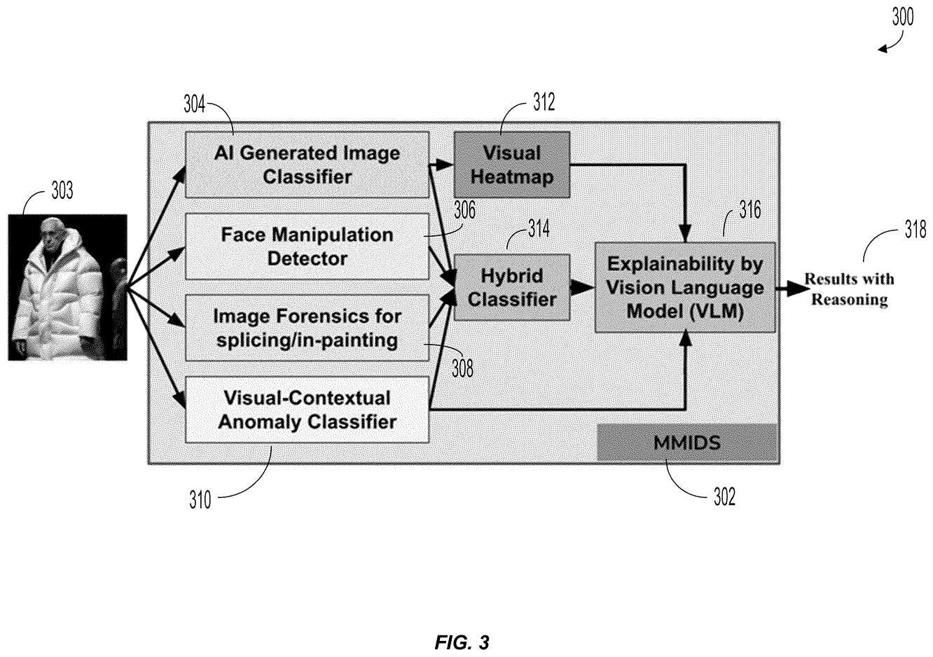

FIG. 3 illustrates an example computing environment 300 for detecting and analyzing artificially-manipulated images, according to some embodiments. As shown in FIG. 3, an input image 303 is processed through an ensemble of classifiers and detectors in parallel, each responsible for identifying a different type of manipulation. The ensemble of the machine-learning models can include an AI-generated image classifier 304, Face manipulation detector 306, Visual-contextual anomaly classifier 310, and Image forgery detector 308. The outputs from the ensemble of classifiers and detectors are then fed into a Hybrid classifier 314, which applies an ensemble-aggregator model to integrate these decisions and provide the final classification result.

To enhance transparency and increase the reliability of the decision of the hybrid classifier, MMIDS 302 incorporates a contextual explainer module, implemented with a multimodal Vision Language Model (VLM). In some instances, the contextual explainer module processes inputs from earlier components, including: (a) the output of the hybrid classifier, (b) part of the output from the Visual-contextual anomaly classifier, and (c) the visual heatmap generated by the GradCam-based heatmap generator. By synthesizing the previous outputs, the Contextual explainer module can generate a detailed narrative content that explains the classification decision, indicating whether the image is classified as real or manipulated.

### 1. AI-Generated Image Classifier

Continuing with FIG. 3, the AI-generated image classifier 304 of the MMIDS 302 is configured to determine whether an input image 303 is a fully AI-generated image. As example and not by way of limitation, MMIDS 302 can be an embedded computer system, a system-on-chip (SOC), a single-board computer system (SBC) (such as, for example, a computer-on-module (COM) or system-on-module (SOM)), a desktop computer system, a mainframe, a mesh of computer systems, a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider (e.g., the computing resources provider 528).

MMIDS 302 can receive the input image 303 through a communication network. The network can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications by the client device via the network can be wired connections, wireless connections, or combinations thereof. Communications via the network can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

MMIDS 302 can receive the input image 303 transmitted from various data sources, including a user device. The user device can be a client device that includes a desktop computer system, a laptop or notebook computer system, a tablet computer system, a wearable computer system or interface, an interactive kiosk, a mainframe, a mesh of computer systems, a mobile telephone, a personal digital assistant (PDA), or a combination of two or more of these.

The input image 303 includes a visual representation of a scene or an object captured by a camera device (e.g., a smartphone camera, video recorder). The input image 303 includes a matrix of pixels, in which each pixel identifies color (e.g., RGB values) and intensity information. The input image 303 can be a video frame of a plurality of video frames. For example, the input image 303 can be a live-preview image of a particular video frame that is presented on the graphical user interface. In some instances, the input image 303 can be encoded in file formats such as JPEG, PNG, or TIFF. The input image 303 can also be associated with metadata that identifies additional information about how or when the input image 303 was captured.

In some implementations, the AI-generated image classifier 304 is configured to detect subtle traces, signatures, or patterns left by AI-image generators and distinguish them from natural images or photographs, even in cases where the input image 303 has been manually retouched by human users.

To implement the AI-generated image classifier 304, we first curated a carefully labeled and balanced dataset using preprocessing techniques such as Clean-Vision, image feature clustering, and anomaly detection to filter out noisy samples. Clean-Vision includes a framework configured to enhance integrity and quality of visual datasets. Clean-Vision systematically identifies and removes problematic samples, such as corrupted images, duplicates, or mislabeled data, which can degrade the performance of machine-learning models (e.g., CNN, LLM). Clean-Vision is configured to analyze visual and metadata properties of images to flag anomalies or inconsistencies. The flagging process helps maintain the dataset's reliability, reducing the risk of bias or errors in downstream tasks like training image recognition models.

Image feature clustering is a technique used to organize images into meaningful sets based on shared characteristics extracted from their visual features. These features can include color distributions, textures, shapes, or higher-level semantic information like objects or scenes. Clustering algorithms (e.g., k-means clustering, hierarchical clustering) can be used to group images together based on their visual features. The image feature clustering can be valuable in filtering noisy samples from datasets, as it enables the identification of outliers that do not conform to the dominant patterns of their respective clusters. By isolating and reviewing such anomalies, the training datasets can be refined and ensure consistency in the data used for training the machine-learning models.

Anomaly detection is a preprocessing technique that includes identifying unusual or unexpected samples within a dataset that deviate significantly from the norm. In the context of filtering noisy samples from visual datasets, anomaly detection algorithms analyze the image features to detect inconsistencies, such as unnatural artifacts, incorrect labels, or images with irrelevant content. The anomaly detection techniques may employ statistical methods, machine learning models, or deep learning approaches to flag anomalies. Once identified, the noisy samples can be reviewed and either corrected or excluded from the dataset. Anomaly detection is advantageous for enhancing the quality of visual datasets, minimizing errors in model training, and improving performance and reliability of the AI-generated image classifier 304. In some instances, an Active Learning method is utilized to select the most important and informative samples for the training process.

For model training, a set of advanced machine-learning architectures, including Convolutional Neural Networks (CNNs) and Vision Transformers, were selected. During training, we applied intelligent, problem-specific data augmentation techniques to improve the models' adaptability to diverse forms of image data. Additionally, advanced optimization techniques were used to enhance the model's resistance to adversarial attacks and anomalies. The data-augmentation techniques are configured to enhance the robustness of the deepfake detection system by closely replicating the transformations images undergo when shared on social media. Unlike existing augmentation techniques, which focus on general computer vision tasks, the present techniques target specific challenges related to manipulated images in social media contexts.

In addition, social media platforms introduce platform-specific compression and resizing, which can obscure manipulation artifacts. To address this, the present techniques simulate these transformations during training. For instance, we apply multiple levels of JPEG compression, mimicking the distortions introduced by social media platforms, and dynamically resize images to match platform-specific dimensions. These augmentations facilitate the model adapt to diverse real-world resolutions and compression-induced degradations, which allows effective detection. Furthermore, intelligent cropping strategies ensure that the training process respects generator-specific aspect ratios and sizes, preserving the visual characteristics essential for manipulation detection.

The present techniques also take into account the impact of perturbations such as blurring, cropping, JPEG compression, and noise on detection performance. For example, while compression and noise can significantly deteriorate detection accuracy, we incorporate these transformations into training to bolster the model's resilience. Unlike existing techniques, the present techniques apply these augmentations consistently, ensuring that the model is exposed to the full range of perturbations likely encountered in real-world scenarios. This makes the augmentations intelligent and problem-specific, as they directly target the behaviors and characteristics of social media image processing.

As an illustrative example, the CNN can be used by the AI-generated image classifier 304 for determining whether the input image 303 is an AI-generated image. The CNN accesses a matrix encoded from the multimodal data and applies a series of operations which form a single convolutional layer: (1) convolution; (2) batch normalization; and (3) max-pooling. To perform convolution, the CNN applies one or more filters including a matrix of values that can “slide over” the embedding matrix so as to generate a set of feature maps. A filter includes a matrix of numbers that are different from a matrix of values of another filter, in order to allow the filter to extract different features from the embedding matrix. In some instances, a set of hyperparameters that correspond to the feature map generation are predefined (e.g., based on manual input). Feature-extraction hyperparameters may identify (for example) a number of filters, a stride for each filter (e.g., 1-step, 2-step), a padding size, a kernel size, and/or a kernel shape. For example, the CNN applies 128 filters, each of which having a kernel size of 5. As a result, 128 feature maps are generated for the text segment.

The CNN can perform a batch normalization operation on the set of feature maps to generate a set of normalized feature maps. As used herein, batch normalization is a supervised learning technique that normalizes interlayer outputs (e.g., the set of feature maps) of a neural network into a standard format. Batch normalization effectively ‘resets’ a distribution of the output of the previous layer to be more efficiently processed by the subsequent layer.

After the batch normalization operation, the CNN performs a pooling operation on the set of normalized feature maps in order to reduce the spatial size of each feature map and subsequently generate a set of pooled feature maps. In some embodiments, the CNN performs the pooling operation to reduce dimensionality of the set of normalized feature maps, while retaining the semantic features captured by the embedding matrix. In some instances, the CNN system performs a max pooling operation to access a group of values within the feature map (e.g., 2 values within the feature map) and selects an element associated with the highest value. This operation can be iterated to traverse the entirety of each feature map of the set of normalized feature maps, at which the max pooling operation completes the generation of the set of pooled feature maps. For example, the CNN sets a pool size of 2 and reduces dimensions for each feature map of the set of normalized feature maps (“128”) by half (“64”). As a result, a dimensionality for each pooled feature map is 64.

The CNN system may alternatively or additionally perform an average pooling operation in place of the max pooling operation which selects the sum or average value of the elements captured in the area within the feature map. By performing the pooling operations, the CNN system may achieve several technical advantages including capability of generating an input representation of the embedding matrix that allows reduction of number of parameters and computations within the CNN model.

The CNN can continue to apply one or more additional convolutional layers at which convolution and pooling operations are performed on the set of pooled feature maps. For example, the CNN generates a second set of feature maps by applying another set of filters to each feature map of the set of pooled feature maps. In addition, the CNN applies a global max pooling operation on the second set of feature maps such that a maximum value for each feature map is selected to form a second set of pooled feature maps.

The CNN applies a fully connected layer (alternatively, a dense layer) to the second set of pooled feature maps to generate a feature representation of the text segment of the input data. The fully connected layer includes a multi-layer perceptron network incorporating a softmax activation function or other types of linear or non-linear functions at an output layer. In some instances, the CNN uses the fully connected layer that accesses the extracted features and generates an output that includes a feature representation that identifies one or more semantic characteristics of the text segment. For example, the feature representation of the text segment is an array of values having an array size of 64. In some instances, the CNN performs the above operations through the remaining text segments represented by the multilingual embeddings, thereby generating feature representations that represent the multilingual embeddings.

The feature representations can then be used as an input for an output layer, which then performs a series of operations for generating an output associated with a given NLP task. In some instances, the output and the labels of the training dataset are used as input for loss functions to optimize the parameters in the CNN. An error value generated by the loss functions is used in backpropagation algorithms to adjust the parameters in the CNN and thus improve the accuracy of subsequent feature representations outputted by the CNN.

It will be appreciated that a different number of convolutional layers may be used (e.g., which may have an effect of repeating these operations can be repeated by the CNN system one or more times). In some instances, pooling operations are omitted for one or more convolutional layers applied by the CNN system. Different versions of the CNN architecture can be used by the CNN system, including but not limited to AlexNet, ZF Net, GoogLeNet, VGGNet, ResNets, DenseNet, etc.

In some instances, to enhance the transparency of the classifier's decision-making process, explainable AI techniques, such as Grad-CAM, were incorporated to generate visual heatmaps 312 that highlight the portions of the image the machine-learning model focuses on during classification. The visual heatmaps 312 can provide valuable insights into how the machine-learning model arrives at its conclusions, ultimately providing additional context and increasing user trust in the classifier's accuracy and decision-making process.

### 2. Face Manipulation Detector

The Face manipulation detector 306 of the MMIDS 302 is configured to detect manipulated or synthesized faces within images or videos, also referred to as deepfakes. For a given input image 303, the face manipulation detector 306 determines whether the faces within the image are real or fake.

To detect synthesized faces in a given image (e.g., the input image 303), the face manipulation detector 306 initially detects the subjects' faces in the image. In some instances, a face detection system (e.g., YOLO detector) is selected and trained using annotated dataset to ensure high-precision face detection. The face detection system operates by leveraging advanced CNNs to detect and localize faces within an image or video stream in real-time. The face detection system such as You Only Look Once (YOLO) is capable of identifying multiple objects, including faces, in a single forward pass. The implementation of the face detection system begins by training the CNNs on a dataset containing annotated images of faces, where each face is labeled with bounding box coordinates. The CNNs learn to associate specific visual features, such as facial contours, eyes, and mouths, with the “face” class. During inference, the input image 303 can be divided into a grid, and CNNs can predict bounding boxes and confidence scores for each grid cell, indicating the likelihood of a face being present. Non-maximum suppression (NMS) is applied to refine the detections by eliminating overlapping or redundant boxes, ensuring only the most accurate detections are retained. The CNNs can be further optimized by incorporating pre-processing steps, such as resizing images to fit the model's input dimensions and applying normalization to enhance detection robustness.

Once the faces are detected and cropped from the input image 303, a binary classifier can determine whether the detected faces are authentic or manipulated. Similar to AI-generated image classifier 304, we first curated an in-house labeled training dataset containing a diverse set of real and manipulated faces. Next, a set of deep learning models were trained and evaluated using both public and proprietary benchmark datasets. To enhance the classifier's robustness, advanced data augmentation techniques were used during the model training phase, ensuring the classifier maintains high performance under various conditions, such as adversarial attacks and image quality degradation. The final model was selected based on its performance, efficiency, and generalizability.

Unlike the AI-generated image classifier 304 that operates on full images, the face manipulation detector 306 is additionally trained to process faces in the input image 303 that have varying sizes and image resolutions. As a result, the face manipulation detector 306 ensures robustness when processing low-resolution inputs and detecting subtle manipulations.

### 3. Image Forgery Detector

The image forgery detector 308 of the MMIDS 302 is configured to identify different types of tampering in images, such as splicing, in-painting, and other types of locally applied image manipulations. The primary objective of the image forgery detector 308 is to detect and localize the pixels that have been modified either by human intervention or through a specialized image-generation model. Unlike the previous two previous classifiers, which operate at the full-image or image-patch level, the image forgery detector 308 performs pixel-level classification to precisely identify tampered regions in the image.

The image forgery detector 308 thus analyzes the input image 303 at a granular level, focusing on inconsistencies in edges, neighboring regions, and texture consistency. To achieve this, the image forgery detector 308 utilizes computer vision models, including image segmentation models and CNNs, to detect the subtle distortions. The output of the image forgery detector 308 is presented as a binary map, which highlights the regions where manipulation has occurred, along with a confidence map that quantifies the certainty of the detection for each pixel.

Training this component presents challenges, particularly due to the high cost of pixel-level image annotation. To overcome this, we aggregated several publicly available datasets used image synthesis techniques to generate additional training data with ground truth binary masks. The enriched training dataset allows the image forgery detector 308 to effectively learn to identify various types of forgeries.

In some instances, the image forgery detector 308 uses CNNs as its backbone architecture. The CNN model can be optimized for the image segmentation task, enabling them to accurately assign a label to each pixel, indicating whether it has been manipulated or remains authentic.

To further enhance the detector's ability, data augmentation techniques were implemented to simulate diverse real-world conditions. The data-augmentation techniques improve the model's generalization across different types of forgery. The present techniques can replicate the diverse and complex conditions that manipulated images encounter in real-world sharing scenarios. Social media platforms often apply transformations such as compression, resizing, and other processing techniques, which obscure subtle artifacts of manipulation. Additionally, user behavior, such as sharing images across multiple platforms or applying manual edits, introduces further complexity.

To simulate these conditions, the present techniques incorporate augmentations that mirror platform-specific behaviors. For instance, by applying various levels of JPEG compression, we mimic the distortions introduced by social media uploads. Dynamic resizing is used to recreate the resolution changes induced by platform-specific scaling policies. Moreover, we apply cropping strategies that preserve generator-specific characteristics, reflecting how manipulated images might be cropped while retaining essential artifacts.

Additionally or alternatively additional perturbations like Gaussian blurring, noise addition, and cropping can be applied followed by upsampling. While some perturbations (e.g., blurring and cropping) may have a limited effect on detection performance, others perturbations such compression and noise can significantly degrade accuracy. By integrating these perturbations into the training process, the present techniques ensure that the model is robust to such transformations. Furthermore, consistent application of these augmentations during training enables the model to better generalize to unseen conditions, even when images are subjected to multiple rounds of platform-specific processing or shared across diverse platforms.

Therefore, the present techniques allow the model to effectively bridge the gap between controlled training datasets and the unpredictable conditions of real-world image sharing. This approach ensures high detection performance, even in scenarios where images have undergone significant degradation or transformation due to social media and user behavior.

The pixel-wise classification task of the image forgery detector 308 can thus be configured to identify subtle manipulation traces rather than semantic categories. Thus, the image forgery detector 308 is tailored to extract these manipulation traces, independent of the image's semantic content.

### 4. Visual-Contextual Anomaly Classifier

The visual-contextual anomaly classifier 310 of MMIDS 302 is configured to detect anomalies within an input image 303 that violate real-world expectations. The primary objective of the visual-context anomaly classifier is to capture inconsistencies between the visual semantics and real-world contextual understanding associated with the input image 303. For instance, a given input image depicting “a mouse driving a car” is contextually unrealistic. Such visual-contextual anomalies can occur at both local (specific objects) and global (overall scene) levels, affecting the foreground or background of the image.

The visual-contextual anomaly classifier 310 leverages a combination of multimodal generative AI-based models that process both visual and textual modalities. MLLMs can be utilized to understand and reason across different types of modalities (e.g., images, text). The visual-contextual anomaly classifier 310 can include a machine-learning model configured to analyze semantic content of the visual modality and compares it with real-world expectations, thereby detecting any contextual inconsistencies.

In some instances, the visual-contextual anomaly classifier 310 includes two components:
1. A vision encoder configured to capture semantic details of the input image 303 and provides a comprehensive description of the visual content. The vision encoder ensures the ensuing machine-learning model to fully understand the relationships between objects and actions within the image.
2. Large Language Model (LLM) configured to analyze image description and performs consistency and anomaly detection by evaluating the content against one or more knowledge bases.

The visual-contextual anomaly classifier 310 is trained using an instruction-tuned MLLMs specifically for anomaly detection. The MLLM model can be fine-tuned on an annotated dataset created using few-shot description and label generation. Experts can verify the descriptions and labels of the dataset to ensure accuracy. The resulting dataset contains a large collection of diverse samples, including both contextually anomalous and realistic images.

The training process incorporates fine-tuning techniques, including efficient optimization strategies such as adapter-based tuning such as LoRA (Low-Rank Adaptation), similar to those used in modern MLLMs. As an illustrative example, adapter-based tuning (e.g., LoRA) can be used for fine-tuning MLLMs by introducing lightweight, trainable layers that modify only a small subset of the MLLMs' parameters. Instead of updating all the model's weights during training, using the adapter-based tuning includes inserting low-rank matrices into specific parts of the machine-learning model, allowing the model to learn task-specific adaptations with minimal computational overhead. Such fine-tuning technique significantly reduces the memory and storage requirements while preserving the original machine-learning model's parameters. The adapter-based tuning can be particularly useful in scenarios with limited computational resources or when adapting pre-trained models to new applications without sacrificing performance. Accordingly, the fine-tuning techniques ensure the machine-learning model generalizes across various contexts. Upon receiving an input image 303, the machine-learning model generates a detailed description of visual contents and provides a classification decision indicating whether the image contains any contextual anomalies.

### 5. Hybrid Classifier

The hybrid classifier 314 of the MMIDS 302 is used as an integration point the system's architecture. The hybrid classifier 314 combines the outputs from all preceding classifiers and detectors to generate a comprehensive, final decision on whether the input image 303 has been manipulated. The hybrid classifier 314 leverages an ensemble-aggregator model to aggregate information from the independent classifiers and detectors: (i) AI-generated image classifier 304; (ii) face manipulation detector 306; (iii) image forgery detector 308; and (iv) visual-contextual anomaly classifier 310. By synthesizing these independent decisions, the hybrid classifier 314 produces a robust final classification that accounts for multiple forms of manipulation. The ensemble-aggregation models ensures that the outputs from the different classifiers are pre-processed, normalized, and weighted according to their relevance and importance. Therefore, it allows MMIDS 302 to effectively handle different types of manipulations.

The hybrid classifier 314 implements a pre-processing step that collects and normalizes the outputs from the different types of manipulation classifiers or detectors. These outputs serve as inputs into the hybrid classifier 314. In particular, the hybrid classifier 314 concatenates the outputs from four independent classifiers into a single vector, which is then used as input for the final classification. It applies a normalizer as an input preprocessing or standardization step. This normalization ensures that the contributions of each classifier are appropriately scaled, preventing any one classifier's outputs from disproportionately influencing the final decision. In some instances, the hybrid classifier 314 applies Z-Score Normalization (Standardization), which transforms the data to have a mean of 0 and a standard deviation of 1. In this technique, each element x is normalized as:

$${x}^{′} = \frac{x - μ}{σ}$$

where μ is the mean and σ is the standard deviation of the vector. This normalization is particularly useful when the classifiers' outputs are normally distributed but differ in mean or variance. It standardizes the inputs, ensuring they are suitable for classifiers that can be sensitive to unscaled inputs.

Additionally or alternatively, the hybrid classifier 314 can apply other techniques. For example, Min-Max Normalization can be used to rescale the values in the concatenated vector to a range, typically [0, 1]. For each element x in the vector, the normalized value x′ is computed as:

$${x}^{′} = \frac{x - min ( x )}{max ( r ) - min ( x )}$$

The Min-Max Normalization ensures that all features contribute equally within the same scale, avoiding dominance by features with larger magnitudes. This is especially useful when the outputs of the individual classifiers vary significantly in scale.

In another example, L2 Normalization can be used to scale the vector so that its L2 norm equals 1. Each element x is normalized as:

$${x}^{′} = \frac{x}{{‖ x ‖}_{2}} = \frac{x}{\sqrt{{\sum }_{i} {x}_{i}^{2}}}$$

The L2 Normalization ensures that the vector's scale is consistent, which can be particularly helpful when the classifier relies on geometric relationships or distance metrics in feature space.

In some instances, the hybrid classifier 314 is trained using gradient boosting ensemble learning techniques. Gradient boosting can be configured to build a predictive model by sequentially combining multiple weak learners (e.g., decision trees) to create a strong learner. Each new machine-learning model in the sequence is trained to correct the errors made by the previous models, minimizing a specified loss function. Gradient boosting can utilize gradient descent to optimize the ensemble, iteratively reducing the residual error.

Similar to the previous classifiers, the hybrid classifier 314 is trained using a dataset created by selecting samples from the individual datasets used to train each preceding classifier. The dataset for the hybrid classifier 314 includes a wide range of image manipulations, allowing the hybrid classifier 314 to generalize across different manipulation types and contexts.

During training, standard cross-validation and bagging techniques were employed to prevent overfitting to specific types of manipulations. For example, cross-validation can include dividing a dataset into multiple subsets (“folds”), and using each fold as a validation set while training the model on the remaining data. This process is repeated for each of the folds, ensuring that every data point is used for both training and testing, providing a robust estimate of the model's generalization performance. Bagging includes training multiple models on different random subsets of the training data and then aggregated, typically by averaging (for regression) or voting (for classification). Bagging reduces model variance, helping to prevent overfitting and improving stability, particularly in high-variance models like decision trees. Additionally or alternatively, offline data augmentation was applied to enhance the training set and ensure the model's adaptability to diverse forms of input data.

As output, the hybrid classifier 314 provides a final classification decision along with the normalized outputs from each independent classifier, to provide transparency in how the classification was reached.

### 6. Contextual Explainer Module

The contextual explainer module 316 of the MMIDS 302 is configured to provide transparency and interpretability. An objective of the contextual explainer module 316 is to explain the decisions made by the hybrid classifier 314 by offering human-understandable reasoning behind the final classification results. The contextual explainer module 316 ensures that users can comprehend the factors contributing to the detection of manipulated or authentic images.

The contextual explainer module 316 integrates outputs from various components of the system to produce multimodal data, in which the multimodal data can include: (a) visual heatmaps 312 provided by the AI-generated image classifier 304; (b) the final decision and normalized outputs from the hybrid classifier 314; and (c) the descriptions of visual content provided by the visual-contextual anomaly classifier 310. The contextual explainer module 316 then applies an MLLM to the multimodal data to generate narrative content 318 that justify the decisions made by the hybrid classifier 314. This approach ensures that the explanation considers both the visually significant regional features and the overall contextual semantics of the image, which are responsible for producing the final classification decision.

By generating the narrative content 318, the contextual explainer module 316 not only identifies and describes manipulated areas but also explains how each classifier contributed to the overall decision. In some instances, the contextual explainer module 316 additionally generates a second set of visual heatmaps to illustrate confidence maps, highlighting the portions of the image that were most influential in the final decision-making process. The user can thus view the target output and the narrative content 318 in both textual and visual formats, enabling easier interpretation of complex decisions.

The contextual explainer module 316 is trained using a curated training dataset. However, the inputs to its MLLM differ significantly, as the contextual explainer module 316 focuses on generating comprehensive justifications for classification decisions.

The following description provides an example implementation of the MLLM for generating the narrative content. In some instances, the MLLM is obtained from a models database. In some instances, the MLLM is trained using self-supervised learning based on a large corpus of text data, such that the MLLM can generate the model-generated narrative content. In addition to training the model, various prompts can be used for prompt engineering of the MLLM for generating the narrative content. Examples of the MLLM can include, but are not limited to, BERT model, Claude LLM, Falcon 40B, Ernie, GPT-3, GPT-3.5, GPT 4, Lamda, and Llama.

### a) Model Selection

In some instances, the machine-learning model can be generated based on different types of machine-learning architectures. An example architecture used for transformer models can include a transformer model that includes an encoder and a decoder. Another example can include a Bidirectional Encoder Representations from Transformers (BERT), which is configured to understand the context of a word in search queries by considering the words on both its left and right.

In yet another example, a machine-learning architecture can include a Generative Pre-trained Transformer (GPT) that is trained using autoregressive language modeling and masked self-attention techniques. For example, the masked self-attention techniques can include masking future tokens when generating a contextual representation representing a given token, such that the contextual representation is determined only based on past tokens. The autoregressive language modeling techniques can then predict the next token of an output sequence based on the contextual representations of the text tokens.

Other examples of machine-learning architectures can include: (1) a Text-to-Text Transfer Transformer (T5) that converts all natural-language processing tasks into a text-to-text format, unifying various tasks under a single model architecture; and (2) a Vision Transformer (ViT) that extends the transformer architecture to process longer text sequences and image data, respectively, thereby facilitating the corresponding model to be used across different domains.

### b) Training Phase

An illustrative example process of training the transformer model (e.g., a GPT model) is as follows. For the training dataset (e.g., the previous input data and corresponding model-generated narrative content), the masked self-attention process can begin by transforming each word in a given training text sequence into three vectors: the query (Q), key (K), and value (V) vectors. A Q vector can represent what information the token is querying about other tokens, a K vector can represent the token's context used to establish relationships with other tokens, and a V vector can represent the token's actual content/information. In some instances, the Q, K, and V vectors can be obtained by multiplying the input embeddings by learned weight matrices.

An attention score for a particular word can be calculated by taking the dot product of the Q vector of the word with the K vectors of all words in the sequence, thereby producing a score that reflects the relevance of each word pair. The attention scores can be used as weights, which can be applied to the Q, K, V vectors to generate a weighted contextual representation of the particular word. Stated differently, the attention score can be used as a weight to transform the Q, K, V vectors of a given word to generate a weighted, computed representation that can be used to train the corresponding transformer model.

In some instances, a mask can be applied to the self-attention mechanism such that a contextual representation of a given token is determined without weights associated with future tokens. As a result, an attention score of a particular token can be adjusted to disregard information from tokens that have not been processed yet. The attention scores can then be scaled by the square root of the key dimension to stabilize training and passed through a softmax function to convert the attention scores into probabilities, ensuring they sum to one. The transformation can identify the most relevant words while downplaying less important ones. The resulting attention weights can then be used to compute a weighted sum of the V vectors, thus producing a new contextual representation for each token that incorporates contextual information from the entire sequence.

To enhance the model's ability to capture various types of relationships, self-attention mechanisms can use multiple sets of Q, K, and V matrices, also referred to as multi-head attention. Each set, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

The transformer model can then be trained using autoregressive language modeling to predict a subsequent token of a target sequence based on the contextual representations that represent the preceding tokens. For each position in the sequence, the transformer model accesses a contextual representation of the token, which was generated using masked self-attention mechanism. The transformer model can then output a probability distribution over a vocabulary for the subsequent token, conditioned on the sequence of preceding tokens. The subsequent token can then be compared with a corresponding token of the training data to calculate a loss. The loss measures the discrepancy between the predicted token and the actual token, providing a signal for the model to adjust its parameters. The loss can then be used to adjust parameters of the transformer model, including the parameters of the Q, K, V matrices.

Through iterative training iterations, the transformer model learns to minimize this loss across the entire training dataset. This process ensures that the model generates coherent and contextually appropriate sequences by leveraging the learned representations and adjusting its parameters based on the training data.

### c) Fine-Tuning Phase Using Prompts

In some instances, the contextual explainer module 316 can construct one or more prompts that can be submitted with the multimodal data 406 to enhance and increase the accuracy of the narrative content 318. As used herein, the term “prompt” can refer to as an input sequence generated to direct a corresponding machine-learning model's generation process towards producing a target output. In some instances, a filtering prompt includes a sequence of text tokens in a specific format (e.g., text, XML data, JSON data) and language (e.g., English, Korean).

In some instances, the prompts are machine-generated prompts that are generated by one or more computer systems without user intervention. For example, the one or more filtering prompts can be constructed using prompt engineering. Prompt engineering can include techniques for designing and implementing prompts within a machine-learning system to generate target responses or actions. In some instances, prompt engineering leverages a combination of linguistic approaches, machine-learning algorithms, and domain knowledge to formulate prompts that elicit specific outputs from a corresponding machine-learning model. The prompt engineering process typically begins with an analysis of a target or a problem domain, followed by the formulation of prompts tailored to achieve the desired results.

As an illustrative example for optimizing prompts, a prompt P can be defined as a sequence of tokens, tailored to elicit specific responses from a machine-learning model. The model employs an objective function O(P, R) to evaluate the quality of generated responses R given the prompt P. The responses R can be generated based on a machine-learning language model LM processing the prompt P (e.g., the function LM(P)). Different types of objective functions can be selected depending on the task and targeted output. For example, an objective function can correspond to a text summarization technique using ROUGE scores. In another example, the objective function can correspond to a translation quality assessment technique using BLEU scores. In some instances, optimization techniques like gradient descent or evolutionary algorithms are used iteratively refine the prompt P to maximize O(P,R), to facilitate the model to consistently produce accurate, relevant, and contextually appropriate outputs (e.g., the narrative content 318). For example, the optimal prompt P* can be determine based on maximizing the objective function O:

$${P}^{*} = arg max O ( P , LM ( P ) ) \qquad Equation ( 1 )$$

Through the iterative refinement process, prompt engineering enhances the corresponding model's performance across various natural language processing tasks, such as generating the narrative content 318 that are contextually relevant to the multimodal data 406.

In some instances, prompt engineering includes a selection of input formats and structures. The input-format selection can include determining the syntactic and semantic characteristics of the prompts that will effectively guide the machine-learning model towards the desired outputs. In some instances, linguistics and computational linguistics can be used to select input formats that are semantically meaningful and contextually relevant. The input-format selection can ensure that the prompts effectively communicate the desired tasks or questions to the machine-learning model. The prompt engineering process can also include an optimization of prompt parameters. The optimization can include fine-tuning various parameters such as prompt length, complexity, and specificity to enhance the machine-learning model's performance on targeted tasks. Different prompt formulations and configurations such as grid search or Bayesian optimization can be implemented to optimize the prompt parameters. Additionally or alternatively, techniques such as zero-shot learning or few-shot learning can be implemented to fine-tune the machine-learning models to generalize from limited prompt examples.

The prompt engineering process can be configured based on an underlying machine-learning model architecture and training data. For example, an appropriate pre-trained machine-learning model architecture (e.g., GPT, BERT, or Transformer) that aligns with the task requirements and available computational resources can be identified for a given task. In some instances, the machine-learning model can be fine-tuned on task-specific data to further improve probability of outputting target responses. Various types of training datasets can be used to train and fine-tune the machine-learning model, so as to enable the machine-learning model to understand and generate responses to prompts accurately.

In some instances, an iterative process of designing, testing, and optimizing prompts is implemented based on feedback from initial model outputs. This iterative approach allows for continuous improvement and refinement of the prompt engineering process, ultimately leading to better-performing machine-learning models. Additionally or alternatively, ongoing monitoring and evaluation of model performance can be used to identify any errors or biases introduced by the prompts and prompt engineering process, in which the feedback data can be generated based on the evaluation. The feedback data can be used to further adjust the parameters of the machine-learning models, such that the machine-learning models can be updated to improve accuracy in generating the target responses.

### d) Deployment Phase

The contextual explainer module 316 can apply the trained and fine-tuned machine-learning model to the multimodal data (e.g., the visual heatmaps 312, the final decision and normalized outputs from the hybrid classifier 314, the descriptions of visual content provided by the visual-contextual anomaly classifier 310) to generate the narrative content 318. To begin the deployment process, the contextual explainer module 316 can tokenize the multimodal data input a sequence of text tokens. For example, the multimodal data can be tokenized to provide the following sequence: [“image”, “includes”, “inconsistent”, “context”, “scenes” . . . ]. In some instances, the machine-learning model uses Byte Pair Encoding (BPE) techniques to further split a single token (e.g., “in”, “sufficient”).

The contextual explainer module 316 can assign each token with a particular index value in the vocabulary (e.g., “context”=E[5]). Then, the contextual explainer module 316 can convert each token into a vector representation (e.g., an embedding) based on a pre-trained embedding matrix. For example, for a vocabulary size V and embedding dimension dᵢ, the embedding matrix E is of size V×d, in which the vector e; can be generated for the text token tᵢ based on using the index value a looking of a corresponding row of embedding matrix E.

$$E : {e}_{i} = E [ {t}_{i} ] \qquad Equation ( 2 )$$

The contextual explainer module 316 can then process the sequence of embeddings (e₁, e₂, e₃, . . . eₙ) that represent the sequence of tokens by adding positional encodings to account for the order of tokens. In some instances, positional encodings are vectors added to each token embedding to inject information about the position of tokens in the sequence. A matrix X can be formed that includes the sequence of position-encoded vectors.

For the matrix X, the contextual explainer module 316 can then determine a contextual representation for each position-encoded vector of the matrix X. In particular, for each position-encoded vector, the contextual explainer module 316 can generate a set of Q, K, V vectors for the position-encoded vector. As described herein, a Q vector can represent what information the token is querying about other tokens, a K vector can represent the token's context used to establish relationships with other tokens, and a V vector can represent the token's actual content/information.

In some instances, to enhance the model's ability to capture various types of relationships, the position-encoded vector can be represented by multiple sets of Q, K, and V matrices (i.e., multi-head attention). Each set of Q, K, V vectors, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

An attention score can be calculated for the set of Q, K, V vectors as follows:

$$Attention ( Q , K , V ) = softmax ( ( Q {K}^{T} ) / √ ( {d}_{k} ) ) V \qquad Equation ( 3 )$$

The (QK^{T})/√(dk) can be used to compute the raw attention scores, in which dk is the dimensionality of the key vectors. Then, the softmax function is applied to the raw attention score to normalize it into a probability distribution. The contextual explainer module 316 can apply the attention score to a V vector of the corresponding set of Q, K, V vectors, such that the weighted Q, K, V vectors can be used as the contextual representation of the position-encoded vector of matrix X. In the instances in which multi-head attention is used, the multiple sets of weighted Q, K, V vectors can be concatenated and linearly transformed using a weight matrix W° to generate the contextual representation of the position-encoded vector. The above process can be iterated through other position-encoded vectors of matrix X to generate a set of contextual representations associated with the multimodal data.

The contextual explainer module 316 can then apply the machine-learning model to the set of contextual representations to generate the narrative content 318. In particular, the machine-learning model can process the set of contextual representations to predict each token of the output, in which the outputted tokens can correspond to the narrative content 318.

### B. Methods

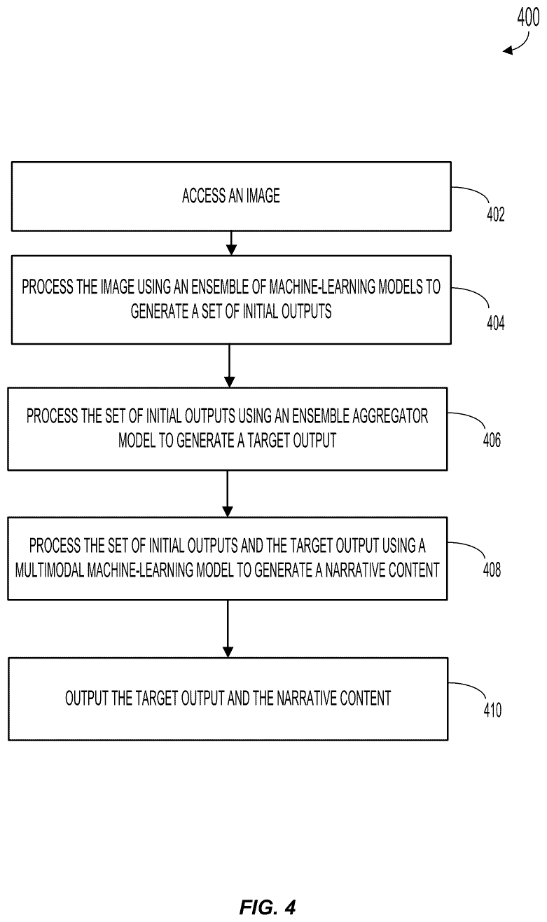

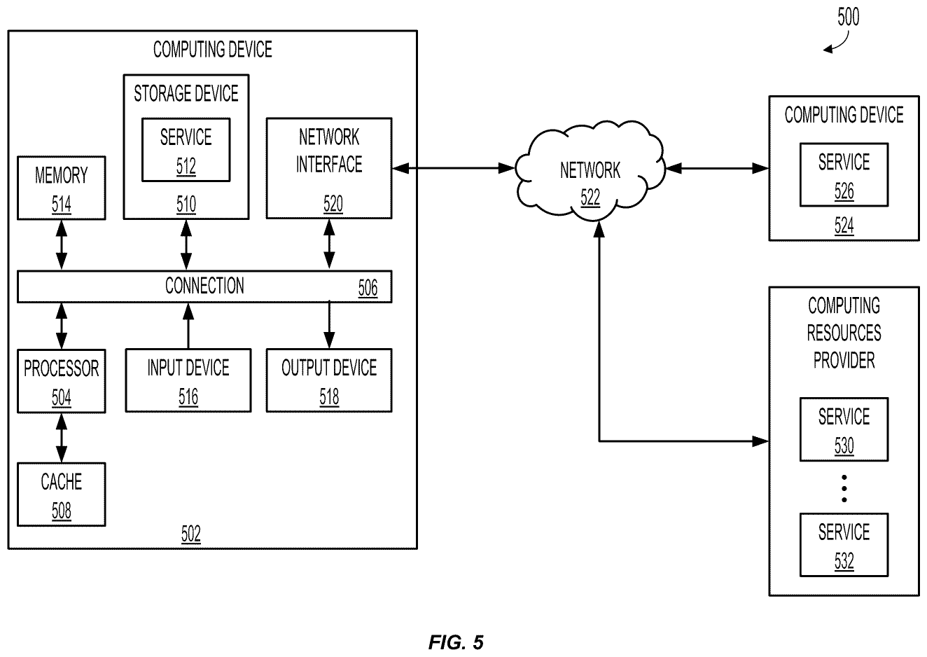

FIG. 4 shows an illustrative example of a process 400 for detecting and analyzing artificially-manipulated images, in accordance with some embodiments. For illustrative purposes, the process 400 is described with reference to the components illustrated in FIGS. 1-3, though other implementations are possible. For example, the program code for the MMIDS 302 of FIG. 3, is executed by one or more processing devices to cause a server system (e.g., the computing device 502 of FIG. 5) to perform one or more operations described herein.

At step 402, a multi-manipulated image detection system accesses an image. The image includes a visual representation of a scene or an object captured by a camera device (e.g., a smartphone camera, video recorder). The image includes a matrix of pixels, in which each pixel identifies color (e.g., RGB values) and intensity information. The image can be a video frame of a plurality of video frames. For example, the image can be a live-preview image of a particular video frame that is presented on the graphical user interface. In some instances, the image can be encoded in file formats such as JPEG, PNG, or TIFF. The image can also be associated with metadata that identifies additional information about how or when the image was captured.

At step 404, the multi-manipulated image detection system processes the image using an ensemble of machine-learning models to generate a set of initial outputs. In some instances, each machine-learning model of the ensemble was trained to generate an initial output predictive of whether a portion of the image corresponds to a particular type of artificially-manipulated visual content.

In some instances, the initial output includes a visual heatmap, in which the visual heatmap identifies one or more pixels of the image processed by a corresponding machine-learning model to generate the initial output. For example, the visual heatmap identifies which portions of the image contribute most to a corresponding machine-learning model's prediction (e.g., CNNs). To generate the visual heatmap, an image classification is generated as one of the initial outputs. The gradient of the predicted classification score can be computed with respect to the feature maps of the last convolutional layer. The gradients represent how much each feature map influences the predicted class score. The gradients are then averaged across all spatial locations in the feature map to produce a set of weights, which indicate the importance of each feature map for the prediction.

The weights can then be used to create a weighted sum of the feature maps, producing a coarse localization map that highlights the regions of the image most relevant to the corresponding model's decision. This map is then passed through a ReLU activation to remove negative values, leaving only the positive contributions to the prediction. The visual heatmap is then upsampled to match the input image's size, creating a visual representation that overlays on the original image, where hotter (“red”) areas represent higher importance, and cooler (“blue”) areas indicate lower importance.

At step 406, the multi-manipulated image detection system processes the set of initial outputs using an ensemble-aggregator model to generate a target output. In some instances, the target output includes a classification of whether the image corresponds to an artificially-manipulated image.

In some instances, the ensemble-aggregator model is trained using gradient boosting ensemble learning techniques. Gradient boosting can be configured to build the ensemble-aggregator model by sequentially combining multiple weak learners (e.g., decision trees) to create a strong learner. Each new machine-learning model in the sequence is trained to correct the errors made by the previous models, minimizing a specified loss function. Gradient boosting can utilize gradient descent to optimize the ensemble, iteratively reducing the residual error.

At step 408, the multi-manipulated image detection system processes the set of initial outputs and the target output using a multimodal machine-learning model to generate a narrative content that describes one or more types of artificially-manipulated visual content predicted to be present on the image.

For example, the narrative content describes that the portion is an artificial-intelligence (AI) generated image, in which the portion includes synthetic visual content generated entirely by artificial intelligence. In another example, the narrative content describes that the portion corresponds to an output generated by a face-manipulation algorithm. In particular, the narrative content can describe that a subject's face depicted in the image is altered or replaced with another face that is artificially generated or extracted from another existing image. In yet another example, the narrative content describes that the portion was modified from an original version of the image.

Additionally or alternatively, the narrative content describes that the portion includes contextually inconsistent visual content. For example, the narrative content can indicate that the portion includes inconsistencies between the visual semantics and real-world contextual understanding associated with the image (e.g., a mouse driving a car).

At step 410, the multi-manipulated image detection system outputs the target output and the narrative content. In some instances, the multi-manipulated image detection system displays the target output and the narrative content on a graphical-user interface of a device (e.g., a browser window). Additionally or alternative, the multi-manipulated image detection system transmits the target output and the narrative content to another device through a communication network. Process 400 terminates thereafter.

### III. System Configurations for Detecting and Analyzing Artificially-Manipulated Images

### A. Pipeline

The MMIDS pipeline can be configured to maximize computational efficiency during inference. For example, MMIDS leverages both parallel processing and asynchronous calls to minimize execution time while maintaining accuracy. The components of MMIDS—AI-Generated Image Classifier, Face Manipulation Detector, Image Forgery Detector, and Visual-Contextual Anomaly Classifier—can be executed in parallel, with each component able to process its task independently. Additionally, MMIDS employs asynchronous calls to allow each classifier to return results as soon as they are available, without waiting for other components to complete. The asynchronous configuration ensures that there is minimal idle time and that outputs are processed by the next stage of the pipeline without delay.

Each machine-learning model of the ensemble also supports efficient batch processing to handle large volumes of data, thereby reducing latency and enabling MMIDS to maintain high throughput. After the parallel classifiers of the ensemble complete their tasks, their outputs are fed into the hybrid classifier, which uses a fast pre-processing step and a lightweight gradient boosting-based classifier to aggregate results efficiently. The contextual explainer module, being the most computationally intensive component, utilizes batch processing to maximize the efficiency of the MLLM to ensure optimal use of computational resources.

As a result, MMIDS's architecture ensures fast and efficient inference by leveraging parallel processing, asynchronous calls, low-overhead model integration, and optimized data flow. Such configuration choices enable MMIDS to deliver real-time, accurate results without compromising performance.

### B. Deployment

MMIDS is configured for flexible deployment across various computing environments, ensuring scalability and robustness. For example, MMIDS can be deployed on local servers, cloud infrastructures, and within dedicated services for secure endpoint management. For large-scale deployment, MMIDS supports distributed architectures, enabling the parallel classifiers and detectors to be spread across multiple processing units or servers. The distributed architecture allows the pipeline to handle high-throughput tasks with minimal delays.

Additionally or alternatively, the pipeline can be containerized using various (e.g., Docker, Kubernetes) to enable seamless scaling, dynamic resource allocation, and fault tolerance. Such deployment strategy ensures that MMIDS can maintain high availability, near real-time performance, and efficient resource management, even under heavy traffic conditions.

To further optimize performance, MMIDS incorporates: (a) an efficient caching mechanism to avoid unnecessary API calls and (b) image hashing-based duplicate detection to manage repeated input data and redundant model inferences. As an illustrative example, image hashing-based duplicate detection can be used to identify identical or near-identical images by converting their respective visual content into a fixed-size hash value. The detection process involves applying a hashing algorithm to an image, which captures key features such as color, texture, and structure. A unique hash code that represents the image's visual fingerprint can then be generated. When comparing different images, their hash values are computed and compared to detect duplicates. In cases where images are altered slightly (e.g., resized or cropped), perceptual hashing algorithms can identify near-duplicates by accounting for small changes in the visual content. The image hashing-based duplicate detection can be utilized to filter out redundant images without comparing pixel by pixel.

In particular, the caching mechanism is configured to optimize the performance of image processing by minimizing redundant computations for previously encountered images. The process involves the computation of two distinct hashes for every incoming API call:
1. File-Based Hash (MD5)—The first hash is a file-based hash, such as MD5. Its primary purpose is to identify exact duplicates of the input file. If an identical file has been processed before, the corresponding cached result can be reused immediately, avoiding unnecessary re-processing.
2. Perceptual Hash (pHash)—The second hash is a perceptual hash (pHash), which generates a hash digest that remains consistent for images with minimal visual differences, such as compression artifacts. This enables the system to detect near-duplicate images efficiently.

After computing these hashes, the system queries the cache—a high-performance, in-memory data structure—to check for existing entries corresponding to the hashes. The cache can be implemented as an in-memory object, such as a dictionary held within the application's memory using Object-Oriented Programming (OOP). Alternatively, the cache can be implemented by an external caching service, which provides scalable, fast, and persistent caching capabilities.

The caching mechanism follows these steps: (i) if either the MD5 or pHash is found in the cache, the cached result associated with the hash is returned directly, bypassing the remaining processing pipeline; or (ii) if neither hash is present in the cache, the image proceeds through the full processing pipeline. Once the processing is complete, the result is stored in the cache system with the computed hashes as keys for future retrieval. The dual-hash approach combines the precision of exact file matching (via MD5) with the flexibility of near-duplicate detection (via pHash). By leveraging a robust caching strategy, the system reduces computational overhead, enhances throughput, and improves response times for frequently processed images, making it highly efficient and scalable.

### C. Application Programming Interface

MMIDS is further configured to handle artificially-manipulated image detection requests with high efficiency through an optimized API service, thereby enabling seamless integration into various applications or services. The API service of MMIDS facilitates developers to incorporate advanced image manipulation detection capabilities, ensuring fast response times even when processing large volumes of images.

By leveraging API asynchronous capabilities, MMIDS can handle multiple detection requests concurrently, making it suitable for both real-time and high-demand scenarios. The API is designed for scalability, allowing the system to dynamically adjust to increased traffic, ensuring consistent and robust performance across a range of deployment environments.

### D. Additional Considerations

MMIDS is also configured to autonomously analyze and identify visually manipulated images, utilizing advanced machine learning and computer vision techniques. This system is highly adaptable, allowing it to be configured for specialized tasks beyond its primary function. For example, while its core operation focuses on detecting AI-generated content, face manipulations, or pixel-level tampering, MMIDS can easily be extended to incorporate additional image analysis tasks, such as deepfake video detection or context-based visual inconsistencies in emerging visual content forms.

MMIDS is configured with modularity and flexibility in mind, enabling it to seamlessly integrate with broader image or content management systems. This adaptability ensures that it can function independently or be embedded within larger computing systems, such as platforms designed for comprehensive media content moderation. When integrated, MMIDS enriches the capabilities of such platforms by providing detailed visual manipulation analysis, complementing existing functionalities like text-based content moderation. For instance, MMIDS can be integrated as a plugin into content moderation platforms via an API that accepts input images or video frames, providing real-time detection and explanation of manipulated media.

Furthermore, MMIDS's architecture is scalable and adaptable, enabling it to extend its capabilities to video manipulation detection without requiring significant architectural changes. Such flexibility makes it an ideal candidate for integration into any multimedia analysis pipeline, enhancing the overall ability of larger systems to manage manipulated content across different media types.

### IV. Example Systems

FIG. 5 illustrates a computing system architecture 500, including various components in electrical communication with each other, in accordance with some embodiments. The example computing system architecture 500 illustrated in FIG. 5 includes a computing device 502, which has various components in electrical communication with each other using a connection 506, such as a bus, in accordance with some implementations. The example computing system architecture 500 includes a processing unit 504 that is in electrical communication with various system components, using the connection 506, and including the system memory 514. In some embodiments, the system memory 514 includes read-only memory (ROM), random-access memory (RAM), and other such memory technologies including, but not limited to, those described herein. In some embodiments, the example computing system architecture 500 includes a cache 508 of high-speed memory connected directly with, in close proximity to, or integrated as part of the processor 504. The system architecture 500 can copy data from the memory 514 and/or the storage device 510 to the cache 508 for quick access by the processor 504. In this way, the cache 508 can provide a performance boost that decreases or eliminates processor delays in the processor 504 due to waiting for data. Using modules, methods and services such as those described herein, the processor 504 can be configured to perform various actions. In some embodiments, the cache 508 may include multiple types of cache including, for example, level one (L1) and level two (L2) cache. The memory 514 may be referred to herein as system memory or computer system memory. The memory 514 may include, at various times, elements of an operating system, one or more applications, data associated with the operating system or the one or more applications, or other such data associated with the computing device 502.

Other system memory 514 can be available for use as well. The memory 514 can include multiple different types of memory with different performance characteristics. The processor 504 can include any general purpose processor and one or more hardware or software services, such as service 512 stored in storage device 510, configured to control the processor 504 as well as a special-purpose processor where software instructions are incorporated into the actual processor design. The processor 504 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 504 can be a microprocessor, a microcontroller, a digital signal processor (“DSP”), or a combination of these and/or other types of processors. In some embodiments, the processor 504 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 500, an input device 516 can represent any number of input mechanisms, such as a microphone for speech, a touch-sensitive screen for gesture or graphical input, keyboard, mouse, motion input, pen, and other such input devices. An output device 518 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 500. In some embodiments, the input device 516 and/or the output device 518 can be coupled to the computing device 502 using a remote connection device such as, for example, a communication interface such as the network interface 520 described herein. In such embodiments, the communication interface can govern and manage the input and output received from the attached input device 516 and/or output device 518. As may be contemplated, there is no restriction on operating on any particular hardware arrangement and accordingly the basic features here may easily be substituted for other hardware, software, or firmware arrangements as they are developed.

In some embodiments, the storage device 510 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 510 can include hardware and/or software services such as service 512 that can control or configure the processor 504 to perform one or more functions including, but not limited to, the methods, processes, functions, systems, and services described herein in various embodiments. In some embodiments, the hardware or software services can be implemented as modules. As illustrated in example computing system architecture 500, the storage device 510 can be connected to other parts of the computing device 502 using the system connection 506. In some embodiments, a hardware service or hardware module such as service 512, that performs a function can include a software component stored in a non-transitory computer-readable medium that, in connection with the necessary hardware components, such as the processor 504, connection 506, cache 508, storage device 510, memory 514, input device 516, output device 518, and so forth, can carry out the functions such as those described herein.

The disclosed systems and service of an multi-manipulated image detection system (e.g., MMIDS 302 described herein at least in connection with FIG. 3) can be performed using a computing system such as the example computing system illustrated in FIG. 5, using one or more components of the example computing system architecture 500. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for detecting and analyzing artificially-manipulated images (e.g., MMIDS 302 described herein at least in connection with FIG. 3) described herein by, for example, executing code using a processor such as processor 504 wherein the code is stored in memory such as memory 514 as described herein. One or more of a user device, a provider server or system, a database system, or other such devices, services, or systems may include some or all of the components of the computing system such as the example computing system illustrated in FIG. 5, using one or more components of the example computing system architecture 500 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 528. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 504 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 514 can be coupled to the processor 504 by, for example, a connector such as connector 506, or a bus. As used herein, a connector or bus such as connector 506 is a communications system that transfers data between components within the computing device 502 and may, in some embodiments, be used to transfer data between computing devices. The connector 506 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 514 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 514 can also include magnetic or optical data storage media including read-only (e.g., CD ROM and DVD ROM) or otherwise (e.g., CD or DVD). The memory can be local, remote, or distributed.

As described above, the connector 506 (or bus) can also couple the processor 504 to the storage device 510, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 510. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 506 can also couple the processor 504 to a network interface device such as the network interface 520. The interface can include one or more of a modem or other such network interfaces including, but not limited to those described herein. It will be appreciated that the network interface 520 may be considered to be part of the computing device 502 or may be separate from the computing device 502. The network interface 520 can include one or more of an analog modem, Integrated Services Digital Network (ISDN) modem, cable modem, token ring interface, satellite transmission interface, or other interfaces for coupling a computer system to other computer systems. In some embodiments, the network interface 520 can include one or more input and/or output (I/O) devices. The I/O devices can include, by way of example but not limitation, input devices such as input device 516 and/or output devices such as output device 518. For example, the network interface 520 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 502 can be connected to one or more additional computing devices such as computing device 524 via a network 522 using a connection such as the network interface 520. In such embodiments, the computing device 524 may execute one or more services 526 to perform one or more functions under the control of, or on behalf of, programs and/or services operating on computing device 502. In some embodiments, a computing device such as computing device 524 may include one or more of the types of components as described in connection with computing device 502 including, but not limited to, a processor such as processor 504, a connection such as connection 506, a cache such as cache 508, a storage device such as storage device 510, memory such as memory 514, an input device such as input device 516, and an output device such as output device 518. In such embodiments, the computing device 524 can carry out the functions such as those described herein in connection with computing device 502. In some embodiments, the computing device 502 can be connected to a plurality of computing devices such as computing device 524, each of which may also be connected to a plurality of computing devices such as computing device 524. Such an embodiment may be referred to herein as a distributed computing environment.

The network 522 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 522 can be wired connections, wireless connections, or combinations thereof. Communications via the network 522 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 522, within the computing device 502, within the computing device 524, or within the computing resources provider 528 can include information, which also may be referred to herein as content. The information may include text, graphics, audio, video, haptics, and/or any other information that can be provided to a user of the computing device such as the computing device 502. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 502 and presented to a user of the computing device 502 using forms that are perceptible via sight, sound, smell, taste, touch, or other such mechanisms. In some embodiments, communications over the network 522 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 502 and/or the computing device 524 can be connected to a computing resources provider 528 via the network 522 using a network interface such as those described herein (e.g. network interface 520). In such embodiments, one or more systems (e.g., service 530 and service 532) hosted within the computing resources provider 528 (also referred to herein as within “a computing resources provider environment”) may execute one or more services to perform one or more functions under the control of, or on behalf of, programs and/or services operating on computing device 502 and/or computing device 524. Systems such as service 530 and service 532 may include one or more computing devices such as those described herein to execute computer code to perform the one or more functions under the control of, or on behalf of, programs and/or services operating on computing device 502 and/or computing device 524.

For example, the computing resources provider 528 may provide a service, operating on service 530 to store data for the computing device 502 when, for example, the amount of data that the computing device 502 exceeds the capacity of storage device 510. In another example, the computing resources provider 528 may provide a service to first instantiate a virtual machine (VM) on service 532, use that VM to access the data stored on service 532, perform one or more operations on that data, and provide a result of those one or more operations to the computing device 502. Such operations (e.g., data storage and VM instantiation) may be referred to herein as operating “in the cloud,” “within a cloud computing environment,” or “within a hosted virtual machine environment,” and the computing resources provider 528 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 528 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 530 and service 532 may implement versions of various services (e.g., the service 512 or the service 526) on behalf of, or under the control of, computing device 502 and/or computing device 524. Such implemented versions of various services may involve one or more virtualization techniques so that, for example, it may appear to a user of computing device 502 that the service 512 is executing on the computing device 502 when the service is executing on, for example, service 530. As may also be contemplated, the various services operating within the computing resources provider 528 environment may be distributed among various systems within the environment as well as partially distributed onto computing device 524 and/or computing device 502.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 502) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 400 of FIG. 4). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistants (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 502.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
accessing an image;
processing the image using an ensemble of machine-learning models to generate a set of initial outputs, wherein each machine-learning model of the ensemble was trained to generate an initial output predictive of whether a portion of the image corresponds to a particular type of artificially-manipulated visual content;
processing the set of initial outputs using an ensemble-aggregator model to generate a target output, wherein the target output includes a classification of whether the image corresponds to an artificially-manipulated image;
processing the set of initial outputs and the target output using a multimodal machine-learning model to generate a narrative content that describes one or more types of artificially-manipulated visual content predicted to be present on the image; and
outputting the target output and the narrative content.

2. The computer-implemented method of claim 1, wherein the narrative content describes that the portion is an artificial-intelligence (AI) generated image.

3. The computer-implemented method of claim 1, wherein the narrative content describes that the portion corresponds to an output generated by a face-manipulation algorithm.

4. The computer-implemented method of claim 1, wherein the narrative content describes that the portion was modified from an original version of the image.

5. The computer-implemented method of claim 1, wherein the narrative content describes that the portion includes contextually inconsistent visual content.

6. The computer-implemented method of claim 1, wherein the image corresponds to a video frame of a plurality of video frames.

7. The computer-implemented method of claim 1, wherein the ensemble-aggregator model is trained using gradient boosting ensemble learning techniques.

8. The computer-implemented method of claim 1, wherein the initial output includes a visual heatmap, wherein the visual heatmap identifies one or more pixels of the image processed by a corresponding machine-learning model to generate the initial output.

9. A system comprising:
one or more processors; and
memory storing thereon instructions that, as a result of being executed by the one or more processors, cause the system to perform operations comprising:
accessing an image;
processing the image using an ensemble of machine-learning models to generate a set of initial outputs, wherein each machine-learning model of the ensemble was trained to generate an initial output predictive of whether a portion of the image corresponds to a particular type of artificially-manipulated visual content;
processing the set of initial outputs using an ensemble-aggregator model to generate a target output, wherein the target output includes a classification of whether the image corresponds to an artificially-manipulated image;
processing the set of initial outputs and the target output using a multimodal machine-learning model to generate a narrative content that describes one or more types of artificially-manipulated visual content predicted to be present on the image; and
outputting the target output and the narrative content.

10. The system of claim 9, wherein the narrative content describes that the portion is an artificial-intelligence (AI) generated image.

11. The system of claim 9, wherein the narrative content describes that the portion corresponds to an output generated by a face-manipulation algorithm.

12. The system of claim 9, wherein the narrative content describes that the portion was modified from an original version of the image.

13. The system of claim 9, wherein the narrative content describes that the portion includes contextually inconsistent visual content.

14. The system of claim 9, wherein the image corresponds to a video frame of a plurality of video frames.

15. The system of claim 9, wherein the ensemble-aggregator model is trained using gradient boosting ensemble learning techniques.

16. The system of claim 9, wherein the initial output includes a visual heatmap, wherein the visual heatmap identifies one or more pixels of the image processed by a corresponding machine-learning model to generate the initial output.

17. A non-transitory, computer-readable storage medium storing thereon executable instructions that, as a result of being executed by one or more processors of a computer system, cause the computer system to perform operations comprising:
accessing an image;
processing the image using an ensemble of machine-learning models to generate a set of initial outputs, wherein each machine-learning model of the ensemble was trained to generate an initial output predictive of whether a portion of the image corresponds to a particular type of artificially-manipulated visual content;
processing the set of initial outputs using an ensemble-aggregator model to generate a target output, wherein the target output includes a classification of whether the image corresponds to an artificially-manipulated image;
processing the set of initial outputs and the target output using a multimodal machine-learning model to generate a narrative content that describes one or more types of artificially-manipulated visual content predicted to be present on the image; and
outputting the target output and the narrative content.

18. The non-transitory, computer-readable storage medium of claim 17, wherein the narrative content describes that the portion is an artificial-intelligence (AI) generated image.

19. The non-transitory, computer-readable storage medium of claim 17, wherein the narrative content describes that the portion corresponds to an output generated by a face-manipulation algorithm.

20. The non-transitory, computer-readable storage medium of claim 17, wherein the narrative content describes that the portion was modified from an original version of the image.

21. The non-transitory, computer-readable storage medium of claim 17, wherein the narrative content describes that the portion includes contextually inconsistent visual content.

22. The non-transitory, computer-readable storage medium of claim 17, wherein the image corresponds to a video frame of a plurality of video frames.

23. The non-transitory, computer-readable storage medium of claim 17, wherein the ensemble-aggregator model is trained using gradient boosting ensemble learning techniques.

24. The non-transitory, computer-readable storage medium of claim 17, wherein the initial output includes a visual heatmap, wherein the visual heatmap identifies one or more pixels of the image processed by a corresponding machine-learning model to generate the initial output.
